(19) United States
(12) Patent Application Publication
(10) Pub. No.: US 2023/0117379 A1
(43) Pub. Date: Apr. 20, 2023

(54) SELF-PROPELLED CART SYSTEM, SELF-PROPELLED CART CONTROL METHOD, AND STORAGE MEDIUM

(71) Applicant: TOYOTA JIDOSHA KABUSHIKI KAISHA, Toyota-shi (JP)

(72) Inventors: Takanori IMAZU, Susono-shi (JP); Yoshiki FUKADA, Susono-shi (JP); Ryuji OKAMURA, Gotemba-shi (JP); Takashi HAYASHI, Mishima-shi (JP); Kohki BABA, Susono-shi (JP); Satoshi OMI, Ebina-shi (JP); Akihiro KUSUMOTO, Susono-shi (JP); Yuta KATAOKA, Tokyo (JP)

(73) Assignee: TOYOTA JIDOSHA KABUSHIKI KAISHA, Toyota-shi (JP)

(21) Appl. No.: 17/964,589

(22) Filed: Oct. 12, 2022

(30) Foreign Application Priority Data
Oct. 18, 2021 (JP) 2021-170351

(51) Int. Cl. G05D 1/02; G05D 1/00; G01C 21/20; G06Q 10/08

(52) U.S. Cl. CPC G05D 1/0285; G05D 1/0011; G01C 21/206; G06Q 10/08355; G05D 2201/0216

(57) ABSTRACT

The position of the vehicle for loading articles on a cart with a self-propelled function is acquired, the travel route of the cart to the vehicle is determined, and the cart is self-propelled to the vehicle along the determined travel route and stopped around the vehicle.

### CROSS-REFERENCE TO RELATED APPLICATION

This application claims priority to Japanese Patent Application No. 2021-170351 filed on Oct. 18, 2021, incorporated herein by reference in its entirety.

### BACKGROUND

### 1. Technical Field

The present disclosure relates to a self-propelled cart system, a self-propelled cart control method, and a storage medium.

### 2. Description of Related Art

A self-propelled cart system is known in which a cart provided with a self-propelled function is adopted and the cart is self-propelled to a cart storage area after an article on the cart is loaded to a vehicle (see, for example, Japanese Unexamined Patent Application Publication No. 2020-129286 (JP 2020-129286 A)).

### SUMMARY

However, there is an issue that, when a large number of articles are mounted on the cart, it is difficult to manually move the cart to the vehicle.

Therefore, according to the present disclosure, a self-propelled cart system includes: an acquisition unit that acquires a position of a vehicle for loading an article on a cart provided with a self-propelled function; a travel route determining unit that determines a travel route of the cart to the vehicle; and a self-propelled control unit of the cart, the self-propelled control unit causing the cart to be self-propelled to the vehicle along the determined travel route and stop around the vehicle.

Further, according to the present disclosure, a self-propelled cart control method includes: acquiring a position of a vehicle for loading an article on a cart provided with a self-propelled function; determining a travel route of the cart to the vehicle; and causing the cart to be self-propelled to the vehicle along the determined travel route and stop around the vehicle. Further, according to the present disclosure, a storage medium stores instructions that are executable by one or more processors and cause the one or more processors to perform functions including: acquiring a position of a vehicle for loading an article on a cart provided with a self-propelled function; determining a travel route of the cart to the vehicle; and causing the cart to be self-propelled to the vehicle along the determined travel route and stop around the vehicle.

This makes a loading operation of the articles to the vehicle easier.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a diagrammatically represented sales facility;

FIG. 2 is a plan view of a diagrammatically represented sales facility;

FIG. 3 is a perspective view of a cart;

FIG. 4 is a diagram showing a travel control device of the cart;

FIG. 5 is a diagram illustrating a management server;

FIG. 6 is a diagram illustrating an example of a procedure for reserving a parking lot;

FIG. 7 is a diagram showing an example of a cart operation procedure;

FIG. 8 is a flowchart for performing an automatic travel instruction of the cart;

FIG. 9 is a flowchart for performing automatic travel control of the cart;

FIG. 10 is a functional configuration diagram of the embodiment according to the present disclosure;

FIG. 11 is a plan view of a sales facility for explaining the second embodiment;

FIG. 12 is a diagram showing an example of a cart operation procedure in the second embodiment;

FIG. 13 is a diagram showing an example of a cart movement request procedure in the second embodiment;

FIG. 14 is a flowchart for performing automatic travel control of the cart in the second embodiment;

FIG. 15 is a plan view of a sales facility for explaining the third embodiment;

FIG. 16 is a diagram graphically illustrating an autonomous vehicle;

FIG. 17 is a flowchart for performing autonomous driving control;

FIG. 18 is a diagram showing an example of a procedure for reserving a parking lot in the third embodiment;

FIG. 19 is a diagram showing an example of a cart operation procedure in the third embodiment;

FIG. 20 is a diagram showing an example of a delivery request procedure of the autonomous vehicle in the third embodiment; and

FIG. 21 is a flow chart for performing autonomous travel control of an autonomous vehicle and a cart in the third embodiment.

### DETAILED DESCRIPTION OF EMBODIMENTS

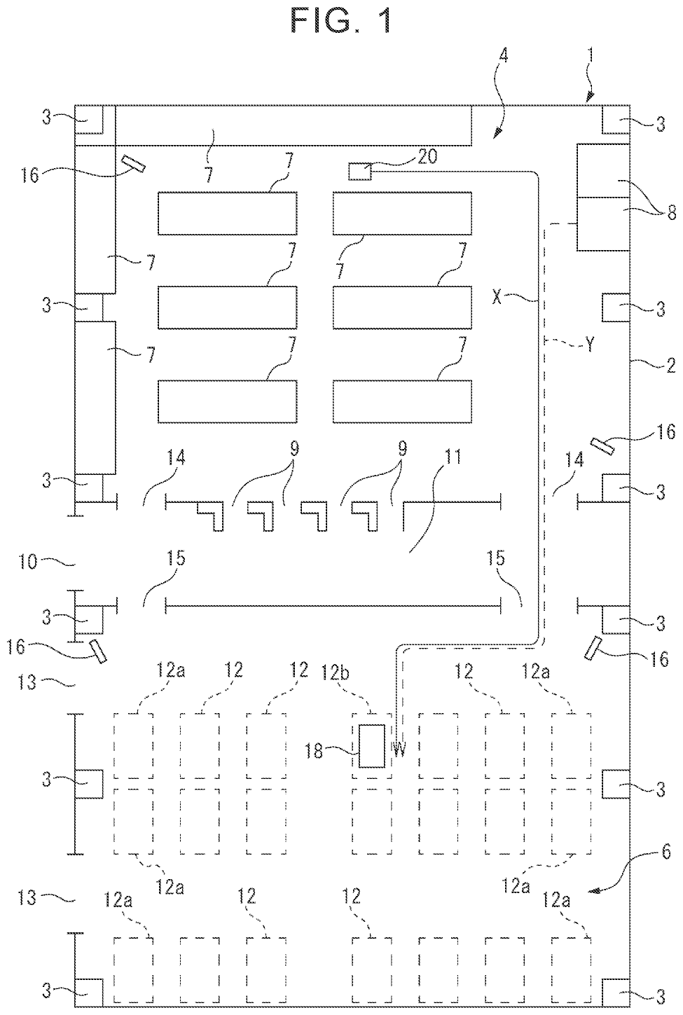

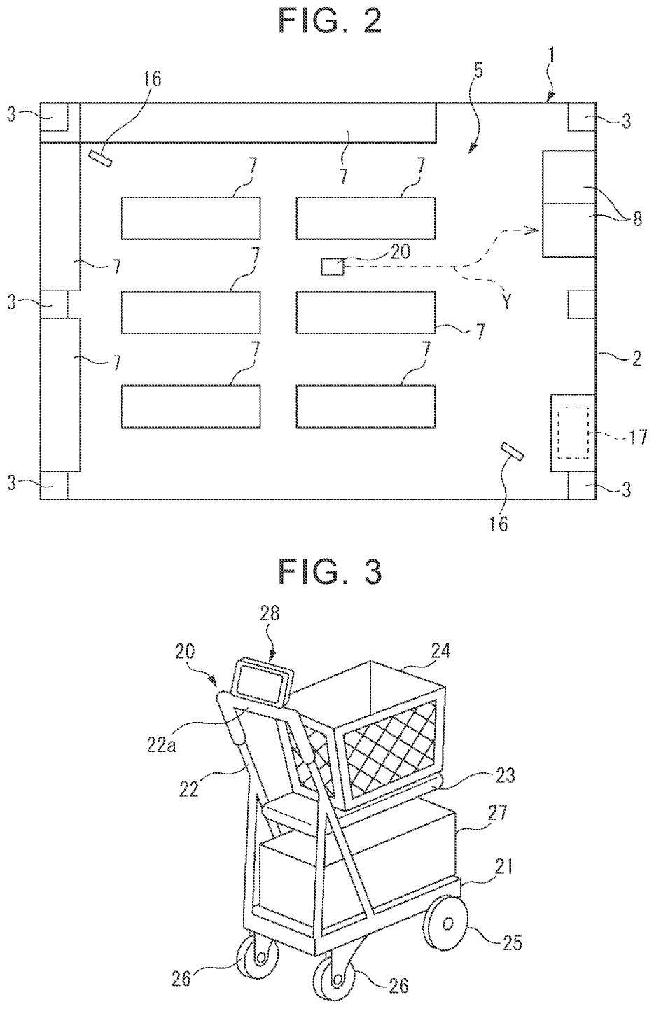

The present disclosure relates to a self-propelled cart system using a cart having a self-propelled function, and the self-propelled cart system can be employed in various environments. In this case, a typical example of the use of this self-propelled cart system can be cited in sales facilities such as department stores and supermarkets. Hereinafter, the present disclosure will be described by taking an example in which a self-propelled cart system is employed in a sales facility such as a department store or a supermarket. FIGS. 1 and 2 show a plan view of a diagrammatically represented sales facility 1. FIG. 1 shows a first floor portion of the sales facility 1, and FIG. 2 shows a second floor portion of the sales facility 1.

Referring to FIGS. 1 and 2, reference numeral 2 denotes an outer wall of the sales facility 1, 3 denotes a pillar of the sales facility 1, 4 denotes a sales area provided in a first floor portion of the sales facility 1, 5 denotes a sales area provided in a second floor portion of the sales facility 1, and 6 denotes a parking area provided in a first floor portion of the sales facility 1. In FIGS. 1 and 2, reference numeral 7 denotes a display shelf on which daily necessities such as food and stationery are displayed, and reference numeral 8 denotes an elevator. In FIG. 1, reference numeral 9 denotes a settlement counter provided in the sales area 4, 10 denotes an entrance/exit of the sales area 4, and 11 denotes a passage in the sales area 4.

On the other hand, each area 12 surrounded by a broken line in the parking area 6 shows the parking space, 13 shows the entrance of the vehicle of the parking area 6. Further, in FIG. 1, 14 shows a passage in which the user travels, 15 shows the entrance of the user to the parking area 6. In the sales areas 4 and 5 and the parking area 6, a large number of infrastructure sensors 16 composed of, for example, surveillance cameras are installed, and only a part of the infrastructure sensors 16 are shown in FIGS. 1 and 2. Further, as shown in FIG. 2, in the management room of the sales facility 1, the management server 17 is installed, the image data taken by each infrastructure sensor 16 is transmitted to the management server 17.

In the sales areas 4, 5, a number of carts 20 with a self-propelled function are run, two of which are shown in FIG. 1 and FIG. 2, respectively. FIG. 3 shows a perspective view of the cart 20. Referring to FIG. 3, the cart 20 is composed of a bottom frame 21, a U-shaped frame 22 extending obliquely upward from the bottom frame 21 and having a grip 22a, and an intermediate height frame 23 coupled to an intermediate height position of the frame 22. Furthermore, a basket 24 for storing purchased goods is supported on the intermediate height frame 23. A pair of drive wheels 25 and a pair of steering wheels 26 are mounted on the bottom frame 21, and a travel control device 27 for controlling the drive wheels 25 and the steering wheels 26 is mounted on the bottom frame 21. Further, an operation device 28 for operating the travel control device 27 is mounted on the frame 22.

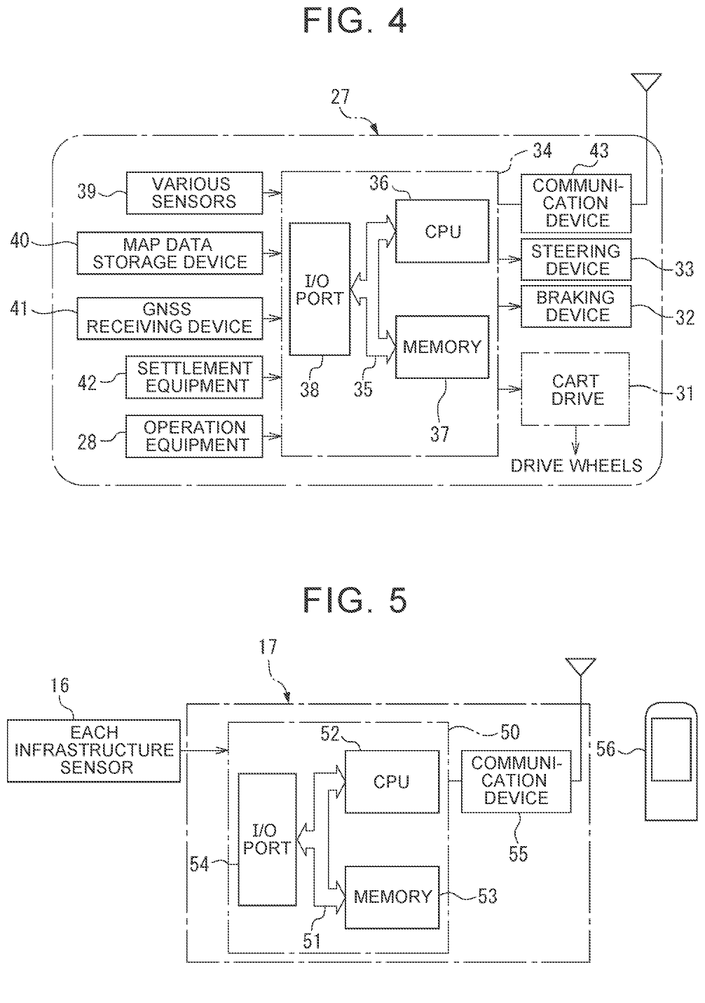

This travel control device 27 is shown in FIG. 4. Referring to FIG. 4, 31 denotes a vehicle drive comprising an electric motor for providing a driving force to the drive wheels 25 of the cart 20, 32 denotes a braking device for braking the cart 20, 33 denotes a steering device for operating the steering wheels 26 of the cart 20, and 34 denotes an electronic control unit, respectively. As shown in FIG. 4, the electronic control unit 34 is composed of a digital computer, and includes a central processing unit (CPU: microprocessor) 36, a memory 37 composed of a read-only memory (ROM) and a random access memory (RAM), and an input/output port 38 that are connected to each other by a bidirectional bus 35.

On the other hand, as shown in FIG. 4, the travel control device 27, various sensors 39 necessary for the cart 20 to perform automatic travel, i.e., a sensor for detecting the state of the cart 20 and a sensor for detecting the periphery of the cart 20 is installed. In this case, as the sensor for detecting the state of the cart 20, an acceleration sensor, a speed sensor, and an azimuth sensor are used, and as the sensor for detecting the periphery of the cart 20, a camera for photographing the front or the like of the cart 20, a LIDAR, a radar, or the like is used. The travel control device 27 is provided with a map data storage device 40. The map data storage device 40, the map data as a reference of the sales area 4, 5 and the entire parking area 6 is stored, the reference map data is always updated.

The travel control device 27 is also provided with a Global Navigation Satellite System (GNSS) receiving device 41. GNSS receiving device 41 can detect the position of the cart 20 (e.g., latitude and longitude of the cart 20) based on the information obtained from the plurality of artificial satellites. Therefore, the present position of the carts 20 can be detected based on the reference map data stored in the map data storage device 40 and the received data from GNSS receiving device 41. As the GNSS receiving device 41, for example, a global positioning system (GPS) receiving device is used. On the other hand, the travel control device 27, the settlement device 42 for performing the balance of the purchased goods is provided. These various sensors 30, the map data storage device 40, GNSS receiving device 41, the settlement device 42, and the operation device 28 mounted on the cart 20 is connected to the electronic control unit 24

It should be noted that various methods are known for detecting the present position of the cart 20, and for example, a Simultaneous Localization and Mapping (SLAM technique of creating a map of the running area of the cart 20 while detecting the position of the cart 20 can be used. In this case, the current position of the cart 20 can be detected by collating the local map around the cart 20 detected by the sensor for detecting the periphery of the cart 20 with the reference map of the running area of the cart 20 stored in the map data storage device 40. On the other hand, in the embodiment according to the present disclosure, the drive control of the drive wheels 25 is performed by an electric motor in accordance with an output signal of the electronic control unit 34, the braking control of the cart 20 is performed by the braking device 32 in accordance with an output signal of the electronic control unit 34, and the steering control of the steering wheels 26 is performed by the steering device 33 in accordance with an output signal of the electronic control unit 34.

On the other hand, FIG. 5 shows the management server 17 installed in the sales facility 1. As shown in FIG. 5, an electronic control unit 50 is installed in this management server 17. The electronic control unit 50 is composed of a digital computer, and includes a CPU (microprocessor) 52, a memory 53 composed of a ROM and a RAM, and an input/output port 54 that are connected to each other by a bidirectional bus 51. Further, a communication device 55 for communicating with the cart 20 is provided in the management server 17. On the other hand, a communication device 43 for communicating with the management server 17 is mounted on the cart 20. FIG. 5 shows a mobile terminal 56 owned by a user of a vehicle using the sales facility 1 and capable of communicating with the communication device 55 of the management server 17 via a communication network.

Here, an outline of the self-propelled cart system according to the present disclosure will be described by taking as an example a case where a vehicle is parked in the parking space 12 of the parking area 6 to purchase goods in the sales facility 1 first, the goods are purchased while moving the cart 20 in the sales areas 4 and 5, and then the goods on the cart 20 are loaded into the vehicle when the purchase of the goods and the settlement of the purchase price are completed. In this case, there are various methods for moving the cart 20 at the time of purchasing the commodity. For example, the drive wheels 25 may be driven by an electric motor to advance the cart 20, the cart 20 may be self-propelled to follow the commodity purchaser, or the robot arm may automatically place the commodity of interest in the basket 24 of the cart 20 that is self-propelled. It is also possible to manually move the cart 20 with the drive wheels 25 and the steering wheels 26 in a structure capable of temporarily freely rotating.

On the other hand, there are various methods for settling the purchase price. For example, it is possible to use a settlement method in which the settlement device 42 is provided with a function of settling by reading a bar code attached to a commodity and the purchased commodity is settled when the purchased commodity is placed in the basket 24 of the cart 20 which is self-propelled, or a settlement method in which the settlement device 42 is provided with a function of settling by reading the content of the RF-tag attached to the commodity by RFID reader and the purchased commodity is placed in the basket 24 of the cart 20 which is self-propelled. It is also possible to perform a settlement process on the purchase price in the settlement counter 9. In any case, when the purchase of the commodities and the settlement of the purchase price are completed, the commodities on the cart 20 are loaded into the vehicle, and in this case, if a large amount of the purchased commodities, that is, a large amount of the commodities is loaded on the cart 20, there is a problem that it is difficult to manually move the cart 20 to the vehicle.

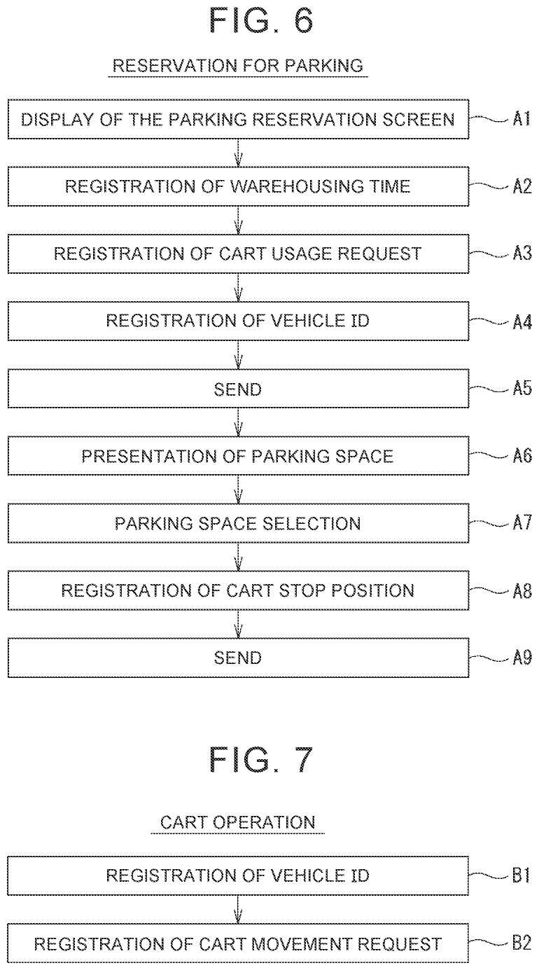

Therefore, in the embodiment according to the present disclosure, the cart 20 is made to run as far as the vehicle. FIGS. 6-9 illustrate a first embodiment for self-propelling the cart 20 to the vehicle. FIG. 6 shows an example of a procedure for reserving a parking lot of the sales facility 1 in order to purchase goods at the sales facility 1. FIG. 6 shows a case where the user of the vehicle makes a parking lot reservation using the mobile terminal 56. Referring to FIG. 6, the user of the vehicle first causes a parking reservation screen to be displayed on the display screen of the mobile terminal 56, as indicated by A1, and registers a desired storage time to the parking lot, as indicated by A2. Next, as indicated by A3, a cart use request requesting the use of the cart 20 is registered, and then, as indicated by A4, a vehicle ID for specifying the vehicle is registered. Next, as indicated by A5, these registered data are transmitted to the management server 17.

On the other hand, in the management server 17, based on the image data taken by the infrastructure sensor 16, the use of the parking space 12 in the parking area 6 is detected. Further, in FIG. 1, some of the parking space indicated by reference numeral 12a is located near the column 3, thus the parking space 12a is located near the column 3, the column 3, the vehicle in the parked coming self-propelled toward, or will prevent the movement of the cart 20 returning to the cart storage place from the vehicle in the parking. Such parking space 12a is previously stored in the memory 53 of the management server 17. Accordingly, when the management server 17 receives a cart use request from the user of the vehicle at the time of reservation of the parking lot, the management server 17 extracts the empty parking space 12 from the parking space 12 other than the parking space 12a, transmits information on the empty parking space 12 from the management server 17 to the mobile terminal 56, and presents the available parking space on the display screen of the mobile terminal 56 as indicated by A6.

When an available parking space is presented on the display screen of the mobile terminal 56, the user of the vehicle selects a desired parking space from among the available parking spaces, as indicated by A7. In FIG. 1, this desired parking space is indicated by 12b, and the vehicle parked in this parking space 12b is indicated by 18. The desired stop position of the cart 20 is then registered with respect to the parked vehicle 18, as indicated at A8. The desired stop position of the cart 20 is a position where articles on the cart 20 can be easily loaded into the vehicle 18, and various methods of setting the desired stop position of the cart 20 are conceivable. For example, there is a method of selecting a term indicating a place displayed on the display screen of the mobile terminal 56 (for example, near the rear door on the left side in the traveling direction, near the rear hood, or the like), or a method of selecting a desired position from a position on the vehicle plan view displayed on the display screen of the mobile terminal 56 (for example, displayed by a check box).

Further, in addition to these methods, the vehicle type name, or, the position of the door, the opening and closing method of the door (rotary type, sliding type, lifting type, gull wing door type) may be registered information relating to the vehicle shape such as. If information on the vehicle type name, or the position of the door, the opening and closing method of the door is present, it is possible to set the more optimal stop position of the cart 20. When the registration of the desired stop position of the cart 20 is completed, the user of the vehicle transmits information on the desired parking space and the desired stop position to the management server 17, as indicated by A9, and the information on the desired parking space and the desired stop position is stored in the memory 53 of the management server 17.

As shown in FIG. 1, whether the vehicle 18 is parked in the desired parking space 12b is determined based on the image data taken by the infrastructure sensor 16. Further, based on the image data taken by the infrastructure sensor 16, the detection of the parking state of the vehicle 18 in the parking space 12b is performed. In the management server 17, the detection result of the parking state of the vehicle 18 in the parking space 12b, based on the information about the desired stop position of the cart 20, the stop position of the cart 20 is determined, the stop position of the determined cart 20 is stored in the memory 53 of the management server 17.

FIG. 7 shows an example of a cart operation procedure when the user of the vehicle 18 uses the cart 20 in the sales areas 4 and 5. Referring to FIG. 7, the user of the vehicle 18 first registers the vehicle ID on the operation screen of the operation device 28 of the cart 20, as indicated by B1. Next, goods are purchased while moving the cart 20. Next, when the purchase of the commodity is completed and the settlement of the purchased commodity is completed, the user of the vehicle 18 registers the movement request of the cart 20 on the operation screen of the operation device 28 of the cart 20, as indicated by B2. When the movement request of the cart 20 is registered, the vehicle ID and the registration data relating to the movement request of the cart 20 are transmitted to the management server 17.

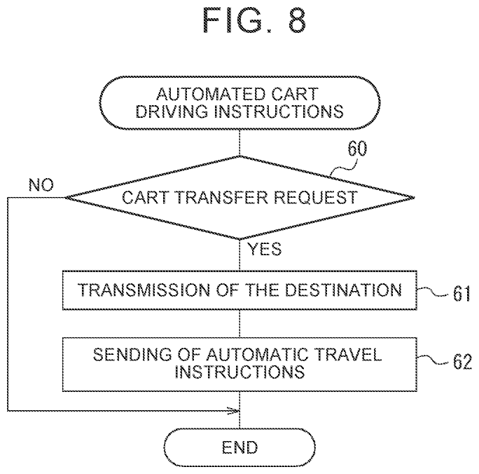

FIG. 8 shows an automatic traveling instruction routine of the cart which is repeatedly executed in the electronic control unit 50 of the management server 17. Referring to FIG. 8, first, in step 60, it is determined whether or not the cart 20 is requested to move. When it is determined that the cart 20 has not been requested to move, the processing cycle is terminated. On the other hand, when it is determined that the movement request of the cart 20 has been made, the process proceeds to step 61, where the stop position of the cart 20 stored in the memory 53 of the management server 17 is set as the movement destination of the cart 20, and the movement destination of the cart 20 is transmitted to the cart 20. Next, in step 62, an automatic travel instruction of the cart 20 is transmitted to the cart 20.

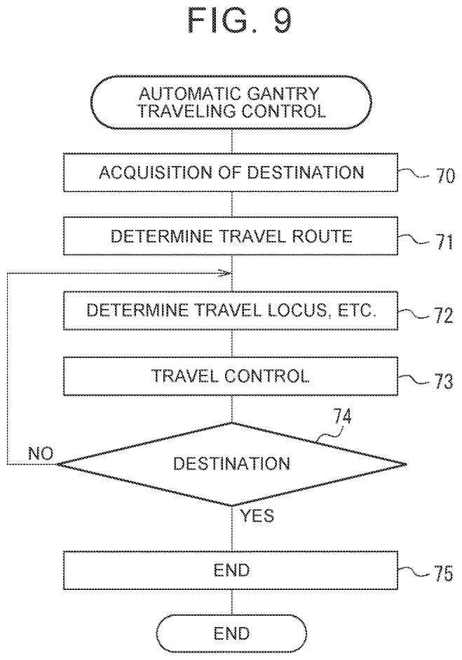

FIG. 9 shows an automatic travel control routine of the cart which is executed in the electronic control unit 34 of the travel control device 27 when the cart 20 receives this automatic travel instruction. Referring to FIG. 9, first, in step 70, the moving destination of the cart 20 is obtained. Then, in step 71, based on the reference map data stored in the map data storage device 40 and received data from GNSS receiving device 41, or using a SLAM technique, the current position of the cart 20 is detected, the current position of the detected cart 20 and the movement destination of the acquired cart 20, based on the reference map of the traveling area of the cart 20 stored in the map data storage device 40, the cart 20 is determined the traveling route of the cart 20 indicating the passage to be traveled. An example of this route of travel is shown in FIG. 1 by the solid arrow X, in which cart 20 is caused to travel on a path along this arrow X. The travel route may be a travel route using the elevator 8, as indicated by a broken arrow Y in FIGS. 1 and 2.

Then, in step 72, based on the detected results of sensors such as cameras, LIDAR, and radars for photographing the front or the like of the cart 20, the travel trajectory of the cart 20 within a predetermined distance range from the current position that can travel without contacting the cart 20 with the other cart 20, the stationary structure, the moving object such as a pedestrian is determined in the travel passage of the cart 20. Furthermore, in step 72, the traveling speed when the cart 20 travels on the traveling trajectory is determined. Next, in step 73, the travel control of the vehicle 20 is performed in accordance with the determined traveling locus and traveling speed. Next, in step 74, it is determined whether or not the cart 20 has reached the moving destination of the cart 20, that is, the stop position of the cart 20 desired by the user of the vehicle 18. When it is determined that the cart 20 has not reached the destination, the process returns to step 72 and the automatic travel of the cart 20 continues. On the other hand, in Step 74, when it is determined that the cart 20 has reached the destination, the process proceeds to Step 75, and the automatic travel of the cart 20 is terminated.

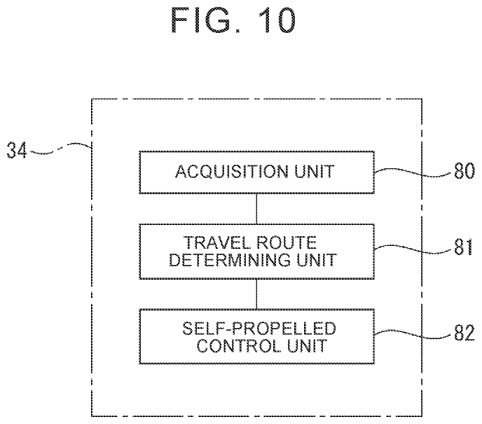

Thus, in the embodiment according to the present disclosure, as shown in the functional configuration diagram of FIG. 10, the self-propelled cart system includes an acquisition unit 80 that acquires the position of the vehicle for loading the articles on the cart 20 having the self-propelled function, a travel route determining unit 81 that determines the travel route of the cart 20 to the vehicle, and a self-propelled control unit 82 of the cart 20 that causes the cart 20 to self-propel to the vehicle along the determined travel route and stops around the vehicle. In this case, the electronic control unit 34 of the travel control device 27 constitutes these acquisition unit 80, the travel route determining unit 81, and the self-propelled control unit 82.

Further, in this case, in the embodiment according to the present disclosure, the self-propelled cart system includes a cart stop position determining unit that determines a cart stop position around the vehicle, and the traveling route of the cart 20 to the cart stop position is determined by the travel route determining unit 81. In this case, in the embodiment according to the present disclosure, the electronic control unit 50 of the management server 17 constitutes the cart stop position determining unit. In this case, in an embodiment according to the disclosure, this cart stop position is determined on the basis of the desired position of the user of the vehicle or the shape of the vehicle.

In the embodiment according to the present disclosure, the position of the vehicle for loading the articles on the cart 20 is a parking position in the parking lot. In this case, the management server 17 for managing the parking position in the parking lot is provided, by the management server 17, the parking position of the vehicle to which the article on the cart 20 is loaded, the movement of the cart 20 It is determined to the parking position without preventing.

Further, in an embodiment according to the present disclosure, there is provided a self-propelled cart control method for acquiring a position of a vehicle for loading articles on a cart 20 having a self-propelled function, determining a travel route of the cart 20 to the vehicle, causing the cart 20 to self-propel to the vehicle along the determined travel route, and stopping around the vehicle. Additionally, embodiments in accordance with the present disclosure provide a storage medium storing a program for having a computer function to acquire the location of a vehicle for loading articles on a cart 20 with a self-propelled function, determine the route of travel of the cart 20 to the vehicle, and cause the cart 20 to self-propel to the vehicle along the determined travel route and stop around the vehicle.

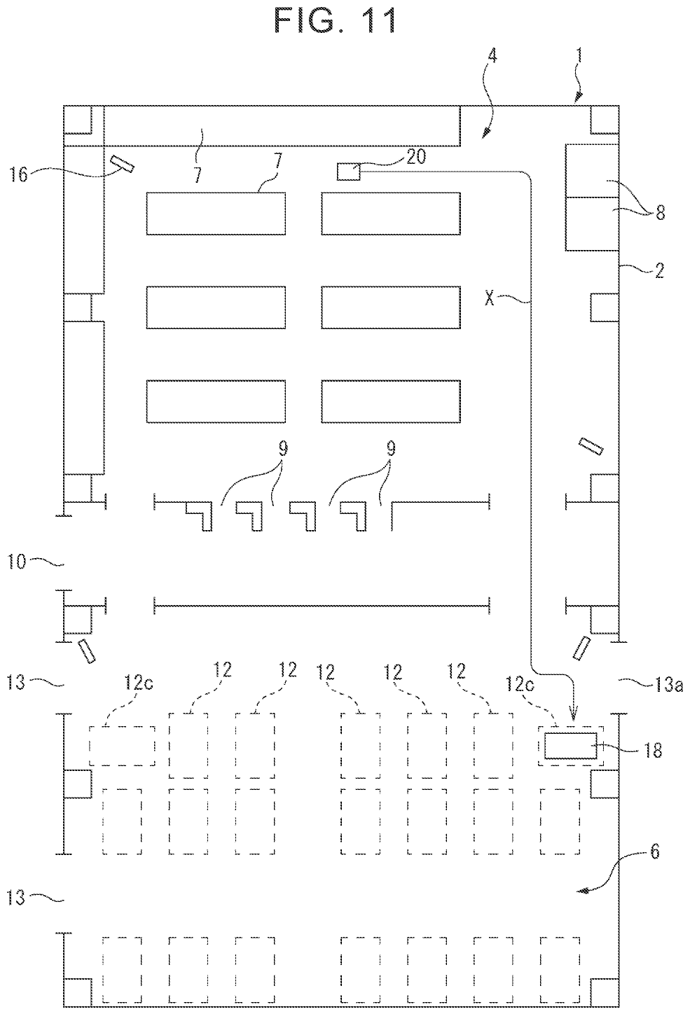

Next, a second embodiment according to the present disclosure will be described with reference to FIGS. 11 to 14. In this second embodiment, the location of the vehicle for loading articles on the cart 20 is illustrated as being a pick-up location specified by the user of the vehicle. FIG. 11 shows a plan view of a sales facility 1 similar to FIG. 1 for explaining the second embodiment. Incidentally, the sales facility 1 shown in FIG. 11 is partially different from the sales facility 1 shown in FIG. 1, in the sales facility 11 shown in FIG. 11, the entrance 13a of the vehicle of the parking area 6 is also provided on the opposite side to the entrance 13 of the vehicle of the parking area 6, the vehicle entrance 13 and the vehicle near the entrance 13a, respectively, the pick-up space 12c for loading articles on the cart 20 is provided It shows a case.

Next, the user of the vehicle utilizing the parking lot, in the pickup space 12c which is considered preferable as viewed from the path of the vehicle after the delivery, for example, the case of loading an article on the cart 20 to the vehicle, a description will be given of the second embodiment. FIG. 11 shows a vehicle 18 which in this example is loaded with articles from a cart 20. In this case, the user of the vehicle may make a reservation of the parking lot or may not make a reservation of the parking lot. When the user of the vehicle makes a parking lot reservation, for example, the parking lot reservation is made in accordance with the parking lot reservation procedure shown in FIG. 6. On the other hand, when the parking lot reservation is not performed, the parking lot reservation procedure shown in FIG. 6 is omitted. Hereinafter, the second embodiment will be described by taking a case where a parking lot reservation is not performed as an example. In this case, the vehicle is parked in any parking space 12 within the parking area 6.

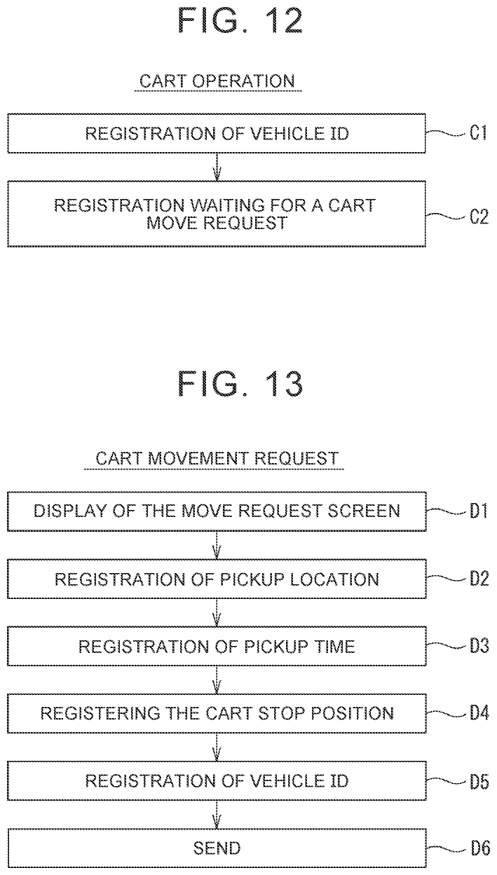

FIG. 12 shows an example of a cart operation procedure when the user of the vehicle uses the cart 20 in the sales areas 4 and 5 in the second embodiment. Referring to FIG. 12, the user of the vehicle first registers the vehicle ID on the operation screen of the operation device 28 of the cart 20, as indicated by C1. Next, goods are purchased while moving the cart 20. Then, when the purchase of the goods is completed and the balance of the purchased goods is completed, the user of the vehicle 18 registers a movement request wait of the cart 20 for waiting for the cart 20 to wait until there is a movement request of the cart 20 on the operation screen of the operation device 28 of the cart 20, as indicated by C2. When the registration of the cart 20 waiting for the movement request is performed, these registration data are transmitted to the management server 17.

FIG. 13 shows an example of a movement request procedure of the cart 20 when a user of the vehicle makes a movement request of the cart 20 in the second embodiment. FIG. 13 shows a case where the user of the vehicle makes a movement request of the cart 20 using the mobile terminal 56. Referring to FIG. 13, the user of the vehicle first causes the movement request screen of the cart 20 to be displayed on the display screen of the mobile terminal 56, as indicated by D1, and registers a desired pickup location, i.e., a desired pickup space 12c, designated by the user of the vehicle for picking up an article on the cart 20, as indicated by D2. Next, as indicated by D3, the desired pickup time in the desired pickup space 12c is registered.

Next, as indicated by D4, the desired stop position of the cart 20 is registered with respect to the vehicle 18 when the vehicle 18 stops in the desired pickup space 12c. Next, as indicated by D5, a vehicle ID for specifying the vehicle is registered. Next, as indicated by D6, these registered data are transmitted to the management server 17.

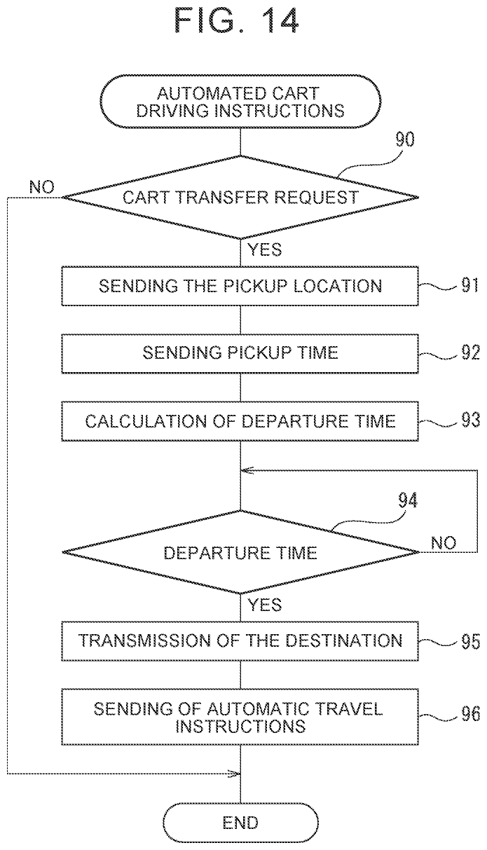

FIG. 14 shows an automatic traveling instruction routine of the cart which is repeatedly executed in the electronic control unit 50 of the management server 17. Referring to FIG. 14, first, in step 90, it is determined whether or not a movement request of the cart 20 has been made. When it is determined that the cart 20 has not been requested to move, the processing cycle is terminated. On the other hand, when it is determined that the movement request of the cart 20 has been made, the process proceeds to step 91, and the desired pickup location is transmitted to the cart 20. Next, in step 92, the desired pick-up time is transmitted to cart 20. Then, in step 93, based on the desired pick-up time, the desired pick-up location and the location of the current cart 20, the departure time of the cart 20 required for the cart 20 to reach the desired pick-up location at the desired pick-up time is calculated. Next, in step 94, it is determined whether or not the departure time of the cart 20 has been reached, and when the departure time of the cart 20 has been reached, the process proceeds to step 95.

Incidentally, also in this second embodiment, as shown in FIG. 11, whether the vehicle 18 is stopped in the desired pickup space 12c is determined based on the image data taken by the infrastructure sensor 16. Further, based on the image data taken by the infrastructure sensor 16, the detection of the stopped state of the vehicle 18 in the desired pickup space 12c is performed. In the management server 17, the detection result of the stop state of the vehicle 18 in the desired pickup space 12c, based on the information about the desired stop position of the cart 20, the stop position of the cart 20 is determined, the stop position of the determined cart 20 is stored in the memory 53 of the management server 17. In step 95, the stop position of the cart 20 stored in the memory 53 of the management server 17 is set as the moving destination of the cart 20, and the moving destination of the cart 20 is transmitted to the cart 20. Next, in step 96, an automatic travel instruction of the cart 20 is transmitted to the cart 20. When the cart 20 receives the automatic travel instruction, the automatic travel control routine of the cart shown in FIG. 9 is executed, and the automatic travel of the cart 20 is started.

Thus, in this second embodiment, the location of the vehicle for loading articles on the cart 20 is the desired pickup location specified by the user of the vehicle. Further, in the second embodiment, the departure time of the cart 20 necessary for the cart 20 to reach the desired pickup time to the designated desired pickup location is calculated, and the cart 20 is made to depart from the departure time. The second embodiment is applicable even when the desired pickup location is set in advance.

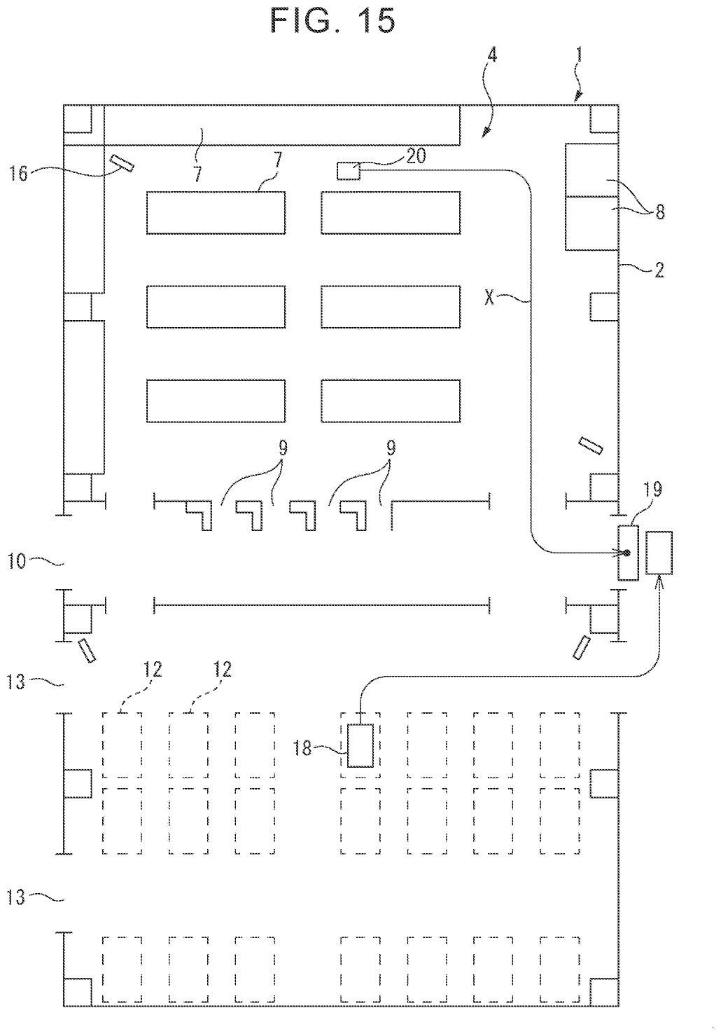

Next, a third embodiment according to the present disclosure will be described with reference to FIGS. 15 to 21. The third embodiment shows a case where an operation of loading articles on the cart 20 into a vehicle is performed at a landing provided in the sales facility 1. FIG. 15 shows a plan view of a sales facility 1 similar to FIG. 11 for explaining the third embodiment. As can be seen from FIG. 15, the sales facility 1 shown in FIG. 15 is partially different from the sales facility 1 shown in FIG. 11, and a landing 19 is provided in the sales facility 1 shown in FIG. 15, and the work of loading articles on the cart 20 into the vehicle is performed in the landing 19.

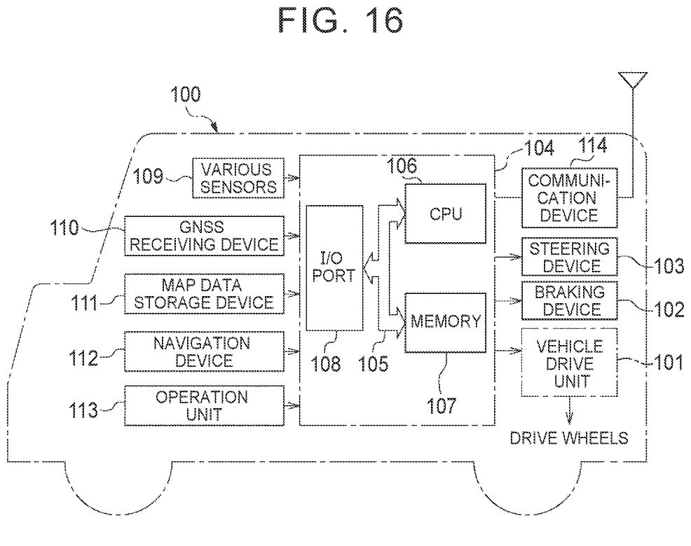

The third embodiment is applicable to both the manually operated vehicle and the autonomous vehicle, the following, for example the case of applying to the autonomous vehicle, will be described a third embodiment. Therefore, first, the autonomous vehicle and the automatic driving control will be briefly described. FIG. 16 shows a diagrammatically represented autonomous vehicle 100. Referring to FIG. 16, the numeral 101 indicates a vehicle drive unit for applying a driving force to drive wheels of the vehicle 100, the numeral 102 indicates a braking device for braking the vehicle 100, the numeral 103 indicates a steering device for steering the vehicle 100, and the numeral 104 indicates an electronic control unit mounted in the vehicle 100. As shown in FIG. 16, the electronic control unit 104 is composed of a digital computer, and includes a central processing unit (CPU: microprocessor) 106, a memory 107 composed of a read-only memory (ROM) and a random access memory (RAM), and an input/output port 108 that are connected to each other by a bidirectional bus 105.

On the other hand, as shown in FIG. 16, the vehicle 100 is provided with various sensors 109 necessary for the vehicle 100 to perform autonomous driving, that is, a sensor for detecting the state of the vehicle 100 and a sensor for detecting the periphery of the vehicle 100. In this case, an acceleration sensor, a speed sensor, and an azimuth angle sensor are used as the sensor that detects the state of the vehicle 100, and a camera for capturing images of the front of the vehicle 100 or the like, light detection and ranging (LIDAR), a radar, or the like are used as the sensor that detects the periphery of the vehicle 100. In addition, the vehicle 100 is provided with a GNSS receiving device 110, a map-data storage device 111, a navigation device 112, and an operation unit 113 for performing various operations. The drive wheels are, for example, driven and controlled by an electric motor, the braking control of the vehicle 20 is performed by the braking device 22, and the steering control of the vehicle 20 is performed by the steering device 23. The map data storage device 111 stores a map in the parking area 6 in addition to a map of a general road.

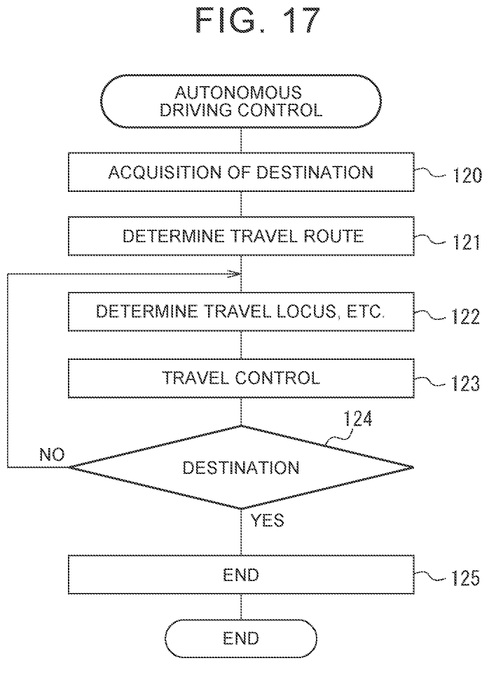

FIG. 17 shows an automatic driving control routine performed in the electronic control unit 104 of the vehicle 100. Referring to FIG. 17, first, in step 120, a destination is acquired. When the destination is determined, the process proceeds to step 121, and the navigation device 112 determines the travel route of the vehicle 100 from the current position to the next destination based on the determined destination and the current position of the vehicle 100 acquired by the GNSS receiving device 110. Next, in step 122, the travel locus and the travel speed of the vehicle 100 are determined so as not to contact other vehicles and pedestrians based on the detection result of a sensor such as a camera for capturing an image of the front or the like of the vehicle 100, a LIDAR, and a radar.

Next, in step 123, the travel control of the vehicle 100 is performed in accordance with the determined traveling locus and traveling speed. Next, in step 124, it is discriminated whether the vehicle 100 has arrived at the destination determined in step 120. When it is discriminated that the vehicle 100 has not reached the destination, the process returns to step 122, and the autonomous driving of the vehicle 100 is continued. On the other hand, when it is discriminated in step 124 that the vehicle 100 has reached the destination, the process proceeds to step 125, and the autonomous driving of the vehicle 100 is temporarily terminated.

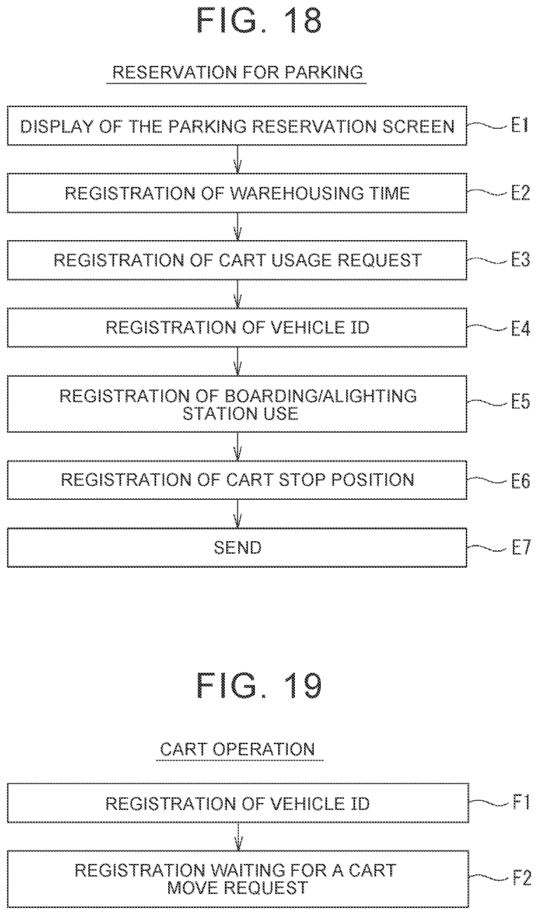

FIG. 18 shows an example of a procedure for reserving a parking lot of the sales facility 1 in order to purchase goods in the sales facility 1. Incidentally, FIG. 18 shows a case where the user of the vehicle performs reservation of the parking lot using the mobile terminal 56. Referring to FIG. 18, the user of the vehicle first causes a parking reservation screen to be displayed on the display screen of the mobile terminal 56 as indicated by E1, and registers a desired storage time to the parking lot as indicated by E2. Next, as indicated by E3, a cart use request requesting the use of the cart 20 is registered, and then, as indicated by E4, a vehicle ID for identifying the vehicle is registered. Next, as indicated by E5, registration to use the landing 19 is performed. Next, as indicated by E6, the desired stop position of the cart 20 is registered with respect to the vehicle 18 stopped at the landing 19. Next, as indicated by E7, these registered data are transmitted to the management server 17.

FIG. 19 shows an example of a cart operation procedure when the user of the vehicle uses the cart 20 in the sales areas 4 and 5 in the third embodiment. Referring to FIG. 19, the user of the vehicle first registers the vehicle ID on the operation screen of the operation device 28 of the cart 20, as indicated by F1. Next, goods are purchased while moving the cart 20. Then, when the purchase of the goods is completed and the balance of the purchased goods is completed, the user of the vehicle 18 registers a movement request wait of the cart 20 for waiting for the cart 20 to wait until there is a movement request of the cart 20 on the operation screen of the operation device 28 of the cart 20, as indicated by F2. When the registration of the cart 20 waiting for the movement request is performed, these registration data are transmitted to the management server 17.

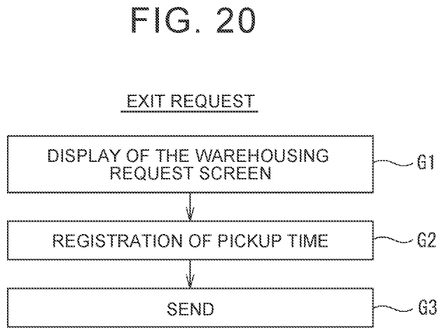

In the third embodiment, the user of the vehicle, an example of the unloading request procedure when performing the unloading request of the autonomous vehicle, shown in FIG. 20. FIG. 20 shows a case where a user of a vehicle makes a delivery request of an autonomous vehicle using a mobile terminal 56. Referring to FIG. 20, the user of the vehicle first displays a vehicle delivery request screen on the display screen of the mobile terminal 56, as indicated by G1, and registers a desired pickup time at the landing 19 for loading articles on the cart 20 into the vehicle and for the user to enter the vehicle, as indicated by G2. Next, as indicated by G3, the registered data is transmitted to the management server 17. Incidentally, in FIG. 15, the autonomous vehicle is parked in the parking lot is indicated by reference numeral 18.

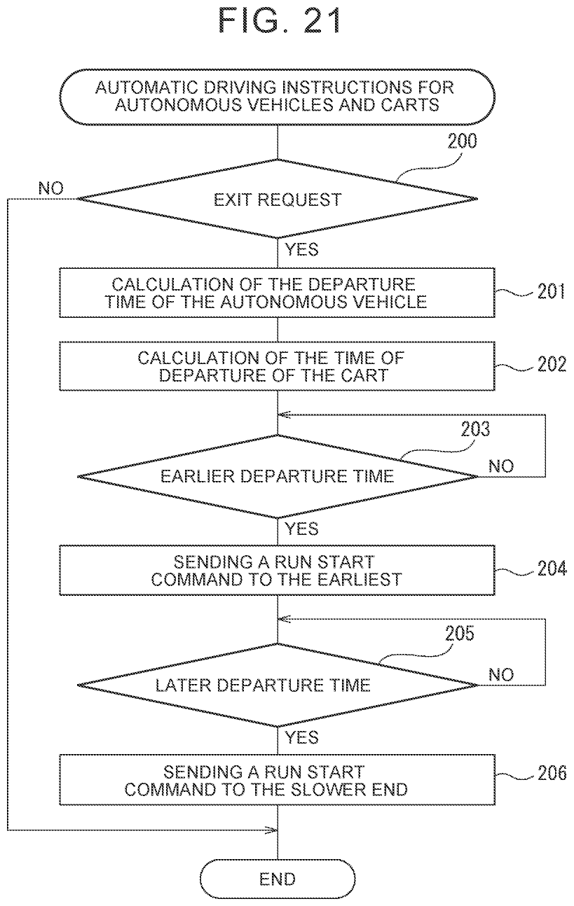

An automatic travel instruction routine for an autonomous vehicle and a cart that is repeatedly executed in the electronic control unit 50 of the management server 17 is shown in FIG. 21. Referring to FIG. 21, first, in step 200, it is determined whether or not the vehicle has been requested to be taken out of storage. When it is determined that the vehicle has not been requested to be taken out of storage, the processing cycle is terminated. In contrast, when it is determined that the delivery request of the vehicle has been made, the process proceeds to step 201, based on the parking position of the desired pickup time and the current autonomous vehicle 18, the autonomous vehicle 18 is required to reach the desired pickup time to the landing 19 departure time of the vehicle 18 is calculated. Next, in step 202, based on the desired pick-up time and the current position of the cart 20, the departure time of the cart 20 required for the cart 20 to reach the desired pick-up time to the landing 19 is calculated.

Then, in step 203, whether or not the departure time of the earlier with the departure time of the departure time and the cart 20 of the autonomous vehicle 18 is determined, when the departure time of the earlier, the process proceeds to step 204, the automatic running instruction is transmitted to the earlier departure time in the autonomous vehicle 18 and the cart 20. Then, in step 205, it is determined whether or not the departure time of the later with the departure time of the departure time and the cart 20 of the autonomous vehicle 18, when the departure time of the later, the process proceeds to step 206, the autonomous vehicle 18 and the cart 20 automatic traveling instruction is transmitted to the later departure time. When the automatic traveling instruction is transmitted to the autonomous vehicle 18, the automatic traveling of the autonomous vehicle 18 is started, when the automatic traveling instruction is transmitted to the cart 20, the automatic traveling of the cart 20 is started. Therefore, in this third embodiment, the management server 17, so that the cart 20 reaches the autonomous vehicle 100 when the autonomous vehicle 100 arrives at a place which is set in advance, the running of the autonomous vehicle 100 and the running of the cart 20 It is managed.

As described above, in the third embodiment, the position of the vehicle for loading the articles on the cart 20 is a predetermined place, for example, the landing 19. In this case, in the third embodiment, the departure time of the cart required for the cart 20 to reach the desired pickup time to the preset location is calculated, and the cart 20 is made to depart from this departure time. Further, in this third embodiment, the vehicle is composed of the autonomous vehicle 100, the management server 17 for managing the traveling and the cart 20 of the autonomous vehicle 100 is provided. In this case, the management server 17, so that the cart 20 reaches the autonomous vehicle 100 when the autonomous vehicle 100 arrives at a place which is set in advance, the running of the autonomous vehicle 100 and the running of the cart 20 is managed.

Alternatively, the system may be configured such that the cart 20 is mounted on the autonomous vehicle 100 with articles loaded on the cart 20, and the user unloads the articles from the cart 20 and descends from the autonomous vehicle 100 when the cart arrives at the destination, and then returns the empty cart 20 to the sales facility 1 by the autonomous vehicle 100. In this case, when arriving at the destination, the cart 20 may be once unloaded from the autonomous vehicle 100 and the cart 20 may be automatically moved to the destination of the article while the article is loaded on the cart 20.

What is claimed is:

1. A self-propelled cart system comprising:
an acquisition unit that acquires a position of a vehicle for loading an article on a cart provided with a self-propelled function;
a travel route determining unit that determines a travel route of the cart to the vehicle; and
a self-propelled control unit of the cart, the self-propelled control unit causing the cart to be self-propelled to the vehicle along the determined travel route and stop around the vehicle.

2. The self-propelled cart system according to claim 1, further comprising a cart stop position determining unit that determines a cart stop position around the vehicle, wherein the travel route determining unit determines the travel route to the cart stop position.

3. The self-propelled cart system according to claim 2, wherein the cart stop position is determined based on a position desired by a user of the vehicle or a shape of the vehicle.

4. The self-propelled cart system according to claim 1, wherein the position of the vehicle for loading the article on the cart is a parking position in a parking lot.

5. The self-propelled cart system according to claim 4, further comprising a management server that manages the parking position in the parking lot, wherein the management server determines the parking position of the vehicle at which the article on the cart is loaded to the vehicle as the parking position at which movement of the cart is not hindered.

6. The self-propelled cart system according to claim 1, wherein the position of the vehicle for loading the article on the cart is a desired pick-up location designated by a user of the vehicle.

7. The self-propelled cart system according to claim 6, wherein:
a departure time of the cart required for the cart to arrive at the desired pick-up location at a desired pick-up time is calculated; and
the self-propelled control unit causes the cart to depart at the departure time.

8. The self-propelled cart system according to claim 1, wherein the position of the vehicle for loading the article on the cart is a preset location.

9. The self-propelled cart system according to claim 8, wherein:
a departure time of the cart required for the cart to arrive at the preset location at a desired pick-up time is calculated; and
the self-propelled control unit causes the cart to depart at the departure time.

10. The self-propelled cart system according to claim 8, wherein:
the vehicle is composed of an autonomous vehicle;
a management server that manages traveling of the autonomous vehicle and traveling of the cart is provided; and
the management server manages the traveling of the autonomous vehicle and the traveling of the cart such that the cart reaches the autonomous vehicle when the autonomous vehicle arrives at the preset location.

11. A self-propelled cart control method comprising:
acquiring a position of a vehicle for loading an article on a cart provided with a self-propelled function;
determining a travel route of the cart to the vehicle; and
causing the cart to be self-propelled to the vehicle along the determined travel route and stop around the vehicle.

12. A storage medium storing instructions that are executable by one or more processors and that cause the one or more processors to perform functions comprising:
acquiring a position of a vehicle for loading an article on a cart provided with a self-propelled function;
determining a travel route of the cart to the vehicle; and
causing the cart to be self-propelled to the vehicle along the determined travel route and stop around the vehicle.
